(19) United States
(12) Patent Application Publication
(10) Pub. No.: US 2020/0137334 A1
(43) Pub. Date: Apr. 30, 2020

(54) IMAGE NOISE CALIBRATION METHOD AND APPARATUS, IMAGE NOISE REDUCTION METHOD AND APPARATUS, AND IMAGE PROCESSING APPARATUS

(71) Applicant: SZ DJI TECHNOLOGY CO., LTD., Shenzhen (CN)

(72) Inventors: Tao HU, Shenzhen (CN); Huaiyu LIU, Shenzhen (CN); Zisheng CAO, Shenzhen (CN)

(21) Appl. No.: 16/725,711

(22) Filed: Dec. 23, 2019

Related U.S. Application Data
(63) Continuation of application No. PCT/CN2017/112440, filed on Nov. 22, 2017.

(51) Int. Cl. H04N 5/365; H04N 17/00

(52) U.S. Cl. CPC H04N 5/365; H04N 17/002

(57) ABSTRACT

An image noise calibration apparatus includes a processor. The processor acquires raw image data output by an image sensor. The image sensor includes an image sensitive unit array, and the raw image data is output by the image sensitive unit array in an optical black state. The processor further determines fixed pattern noise calibration data of the image sensor based on the raw image data output by the image sensitive unit array. The fixed pattern noise calibration data is used for noise reduction of the image sensitive unit array, and the number of the fixed pattern noise calibration data is less than the number of image sensitive units in the image sensor.

### CROSS-REFERENCE TO RELATED APPLICATION

This application is a continuation of International Application No. PCT/CN2017/112440, filed Nov. 22, 2017, the entire content of which is incorporated herein by reference.

### TECHNICAL FIELD

The present disclosure relates to an image noise reduction technology and, more particularly, to an image noise calibration method and apparatus and an image noise reduction method and apparatus for an image processing apparatus, and an image processing apparatus thereof.

### BACKGROUND

In recent years, with the popularization and wide application of image sensors, such as a complementary metal-oxide-semiconductor transistor (CMOS), image quality and noise processing have also attracted great attention. Fixed pattern noise (FPN), as a non-random noise, often occurs in sensors. Due to the composition of the image sensors, each photodiode needs to be paired with an ADC (analog-to-digital converter) amplifier. For megapixel image sensors, a large number of ADC amplifiers are required. Due to individual differences in photodiodes for each pixel, and the variations of dopant concentration and the field-effect transistor, the spatial difference in the output signal is caused to the pixels, and this difference usually does not change with time, thereby causing corresponding fixed pattern noise.

Currently, there are two main types of noise suppression algorithms for FPN, namely on-chip noise reduction and off-chip noise reduction. The principle of on-chip noise reduction is that: First, after an integration time, a pixel outputs a signal containing the photo-generated signal and the amplifier offset, which is stored in the on-chip memory cell. Next, after the pixel is reset, a signal containing only the amplifier offset is output, which is stored in another on-chip memory cell. By making a difference between the two outputs, the offset of the amplifier may be eliminated, thereby achieving the purpose of eliminating the FPN. On-chip noise reduction requires an image sensor with on-chip special hardware circuitry and several memory cells for signal storage and comparison. Off-chip noise reduction requires a back-end image signal processor (ISP) to have an FPN noise reduction function and to be able to provide an additional frame cache. The principle of off-chip noise reduction is similar to that of the on-chip solution. Due to the existence of the frame cache, in addition to requiring a large storage overhead, a long delay and more sensor mode switching may also be expected, thereby affecting the real-time performance and stability of the system. In addition, the FPN needs to be re-acquired each time the system is turned on or each time the mode is switched, which may also cause a delay.

### SUMMARY

In accordance with the present disclosure, there is provided an image noise calibration apparatus. The image noise calibration apparatus includes a processor. The processor executes a computer readable instruction set to acquire raw image data output by an image sensor, where the image sensor includes an image sensitive unit array, and the raw image data is output by the image sensitive unit array in an optical black state. The processor next determines FPN calibration data of the image sensor based on the raw image data output by the image sensitive unit array, where the number of the FPN calibration data is less than the number of image sensitive units in the image sensor. The FPN calibration data is then used for noise reduction of the image sensitive unit array.

Also in accordance with the disclosure, there is provided an image noise reduction apparatus. The image noise reduction apparatus includes a noise reduction module that is configured to perform a noise reduction process on raw image data output by an image sensor. The noise reduction process includes acquiring the raw image data output by the image sensor, calculating compensation data of the raw image data according to pre-stored FPN calibration data of the image sensor, and compensating the raw image data based on the compensation data.

### BRIEF DESCRIPTION OF THE DRAWINGS

FIG. 1 is a schematic structural diagram of an image processing apparatus according to an embodiment of the present disclosure.

FIG. 2 is a flowchart of an image noise reduction method according to an embodiment of the present disclosure.

FIG. 3 is a schematic diagram of characteristic calibration according to an embodiment of the present disclosure.

FIG. 4 is a flowchart of adaptive noise reduction of an image noise reduction method according to an embodiment of the present disclosure.

FIG. 5 is a schematic diagram of image compensation according to an embodiment of the present disclosure.

FIG. 6 is a schematic diagram of a comparison of noise reduction effects according to an embodiment of the present disclosure.

FIG. 7 is a schematic structural diagram of an image noise calibration apparatus according to an embodiment of the present disclosure.

FIG. 8 is a schematic structural diagram of an image noise reduction apparatus according to an embodiment of the present disclosure.

FIG. 9 is a schematic structural diagram of an image processing apparatus according to an embodiment of the present disclosure.

### DETAILED DESCRIPTION OF THE EMBODIMENTS

Technical solutions of the embodiments of the present disclosure will be made in detail hereinafter with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

To make the objective, technical solutions, and advantages of the present disclosure clearer, the technical solutions of the present disclosure will be made in detail hereinafter with reference to the accompanying drawings. Apparently, the described embodiments are merely some, but not all, of the embodiments of the present disclosure. Various other embodiments obtained by a person of ordinary skill in the art based on the embodiments of the present disclosure without creative efforts still fall within the protection scope of the present disclosure.

The present disclosure provides an image processing apparatus, which may be an image processing module applied to various electronic devices, such as a camera or a heat dissipation structure integrated into a terminal electronic device (e.g., a mobile phone or a tablet), or a stand-alone photographing device (e.g., a camera). The camera may be applied to a mobile platform including, but not limited to, an aircraft, a spacecraft, and the like.

The image processing apparatus includes an image sensor for sensing an optical signal to acquire raw image data. The image sensor includes an image sensitive unit array. The raw image data may be initial data obtained by analog-to-digital conversion of a voltage or current signal output by the image sensitive unit array.

The present disclosure provides an image noise reduction method. The image noise reduction method performs real-time noise reduction on the raw image data output by the image sensor based on pre-stored FPN calibration data. The FPN calibration data may be pre-stored in a storage unit of a noise reduction module of the image processing apparatus or in the storage unit of a third-party processing apparatus, where the noise reduction module is an image sensor, an image processor, or a noise reduction circuit connected to the image sensor.

In the image noise reduction method, the compensation of the raw image data may be implemented in a noise reduction module of the image processing apparatus, where the noise reduction module is an image sensor, an image processor, or a noise reduction circuit connected to the image sensor.

The image noise reduction method includes: acquiring raw image data output by the image sensor; calculating compensation data of the raw image data according to pre-stored FPN calibration data of the image sensor; and compensating the raw image data based on the compensation data.

In one embodiment, the image noise reduction method further includes: first generating a compensation level K according to exposure information of the image sensor. The FPN calibration data is calculated under a specific calibration environment (e.g., with specific exposure parameters). However, exposure information of the image sensor is automatically adjusted when the image data is sensed under normal conditions, which may be different from the values under the calibration environment. Therefore, the image data needs to be adjusted by a compensation level K. After the compensation level K value is determined, the raw image data output by the image sensor is compensated according to the FPN calibration data and the compensation level K value, thereby achieving the goal of denoising. The specific algorithm for calculating the K value and the algorithm for compensating the raw image data according to the FPN calibration data and the K value are described further in detail in the following embodiments.

There are various approaches to acquire the pre-stored FPN calibration data. The present disclosure also provides an image noise calibration method, which includes: acquiring raw image data output by an image sensor, where the image sensor includes an image sensitive unit array, and the raw image data is output by the image sensitive unit array in an optical black state; determining FPN calibration data of the image sensor based on the raw image data output by the image sensitive unit array in the optical black state, where the FPN calibration data is used for noise reduction of the image sensitive unit array, and the number of the FPN calibration data is smaller than the number of image sensitive units in the image sensor.

In one embodiment, the image noise calibration method further includes: acquiring an dark current correction value (may also be referred to as “optical black value” or “OB value”) of the image sensitive unit array; and determining the FPN calibration data of the image sensor based on the raw image data output by the image sensitive unit array and the dark current correction value of the image sensitive unit array, where the FPN calibration data of the image sensor is a value with the dark current correction value being removed.

The OB value is data output by the sensor due to the presence of dark current under optical black conditions. This data is related to the image sensor itself and is a constant value, which is usually measured and provided by the manufacturer when an image sensor is shipped. In some embodiments, the OB value may also be determined from the sensed data output by the image sensor. For example, the vertical OB and/or the horizontal OB are calculated from the raw image data. Generally, in an ideal standard state, the pixel value of the raw image data sensed by the image sensor in the OB state is the same as the OB value. However, due to the intrinsic factors of the various sensors, such as the individual difference of the sensing unit corresponding to each pixel and the dopant concentration, the pixel value may be caused to deviate from the OB value. The FPN calibration data is then calculated based on the deviation of the pixel value from the OB value. For specific methods of calculating the FPN calibration data, refer to the following embodiments. In some embodiments, the FPN calibration data may be generated before leaving the manufacturer, or may be generated when a user first uses the image processing apparatus, or may be generated later according to actual needs of a user (e.g., when resetting an image processing apparatus).

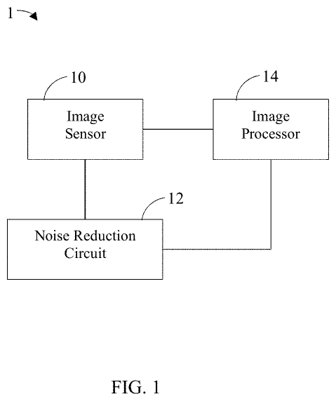

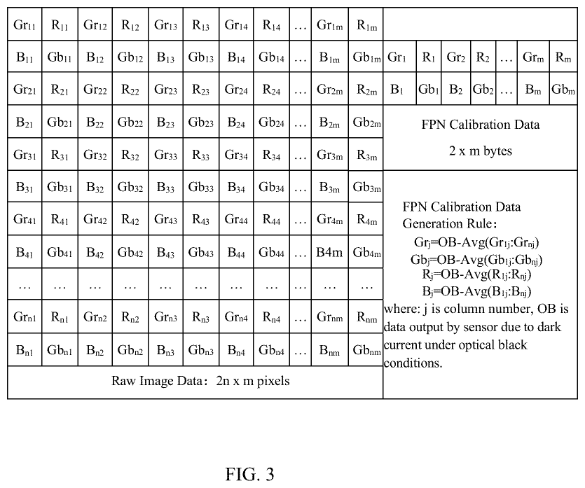

FIG. 1 is a schematic structural diagram of an image processing apparatus according to an embodiment of the present disclosure. The image processing apparatus 1 includes an image sensor 10, a noise reduction circuit 12, and an image processor 14. The image sensor 10 is configured to sense an optical signal to obtain raw image data. The image sensor 10 includes an image sensitive unit array, and the raw image data may be RGB (red, green, blue) mode digital raw data obtained by analog-to-digital conversion of a voltage or current signal output by the image sensitive unit array. In some embodiments, the raw image data is pixel values arranged in rows and columns (as shown in FIG. 3). The image sensor 10 may be a CCD (charge-coupled device) and a CMOS or other similar devices capable of converting an optical image into an electronic signal.

The noise reduction circuit 12 may be a complex programmable logic device (CPLD), a field programmable gate array (FPGA), or other similar programmable logic devices, a discrete gate or a transistor logic device, discrete hardware components, etc. The noise reduction circuit 12 is configured to store the FPN calibration data. When implementing the noise reduction, the noise reduction circuit 12 calculates the compensation data according to the FPN calibration data, and then compensates at least part of the pixels in the raw image data sensed by the image sensor 10 according to the compensation data. In some embodiments, the FPN calibration data is determined according to a compensation level. In some embodiments, the FPN calibration data may also be determined without considering a compensation level. For example, when the image sensor does not change much under different conditions (e.g., different exposure gains or at different temperatures), the compensation level may not be considered, and the compensation data may be directly determined based on the FPN calibration data.

In some embodiments, the image processor 14 is configured to acquire information collected by the image sensor 10 and determine whether the noise reduction function of the noise reduction circuit 12 should be enabled according to the collected information. In some embodiments, the image processor 14 is further configured to generate a compensation level according to the collected information of the image sensor 10. In some embodiments, the collected information of the image sensor 10 includes, but is not limited to, exposure gain (EG), exposure time, etc. The EG includes an analog gain (AG), digital gain (DG). In some embodiments, the system EG value of the image processing apparatus 1 may be set to the product of AG and DG. The image processor 14 may be a central processing unit (CPU), another general-purpose processor, a digital signal processor (DSP), an application specific integrated circuit (ASIC), or a field-programmable gate array (FPGA), etc. The general-purpose processor may be a microprocessor, or any conventional processor, etc. The processor 71 is a control center of the image processing apparatus 1, which connects the various units of the entire image processing apparatus 1 by using various interfaces and lines/wires.

The image sensor 10 is connected to the noise reduction circuit 12 and the image processor 14, respectively. In some embodiments, the image sensor 10 may be coupled to the noise reduction circuit 12 and the image processor 14 in a variety of serial or parallel manners, for example, inter-integrated circuit (I2C) bus, general purpose I/O ports (GPIO), universal serial bus (USB), controller area network (CAN), other serial or parallel communication connection interfaces, etc. In the disclosed embodiment, the image sensor 10 is communicatively connected to the noise reduction circuit 12 and the image processor 14 via an I2C bus.

The image processor 14 and the noise reduction circuit 12 may also be communicatively connected through various serial or parallel communication interfaces, for example, mobile industry processor interface (MIPI), low-voltage differential signaling (LVDS), high definition multimedia interface (HDMI), I2C bus, GPIO, etc. In some embodiments, the image processor 14 reads data from and transmits control commands to the noise reduction circuit 12 and the image sensor 10 through the same or different communication interfaces. For example, the image processor 14 may read data from the noise reduction circuit 12 via MIPI, and control commands may be sent to the noise reduction circuit 12 via I2C or GPIO. The image processor 14 may be an ISP.

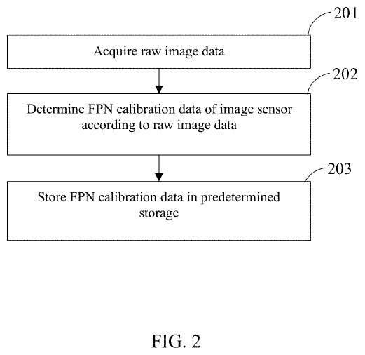

An embodiment for obtaining pre-stored FPN calibration data will be described hereinafter with reference to FIG. 2. FIG. 2 is a flowchart of a method for image noise calibration according to an embodiment of the present disclosure.

Step 201: Acquire raw image data output by the image sensor.

The image sensor 10 includes an image sensitive unit array. The raw image data is output by the image sensitive unit array in an optical black state.

In some embodiments, the calibration environment of the image sensor is first set. Optionally, the calibration environment setting includes:

a) the image sensor 10 and the image processor 14 are connected properly, and the power supply is normal;

b) the image sensor 10 is in an OB state;

c) the image processor 14 is working properly;

d) the noise reduction circuit 12 operates in a non-FPN denoising state (at this moment, the FPN calibration data is empty, and the FPN check data is 0).

The image sensor 10 still has a dark current under the optical black condition, and outputs data which is related to the property of the image sensor 10 and is a fixed value.

Optionally, the operating parameters of the image sensor are also configured. For some image sensors, the applicants have found that the FPN of an image sensor changes with the change of the operating parameters of the image sensor. Therefore, the operating parameters of the image sensor are configured such that the FPN of the image sensor becomes more obvious. For example, the operating parameters setting includes: the auto exposure (AE) mode is set to the manual mode; the AG and the DG of the image sensor 10 are respectively set to preset values. In the disclosed embodiment, the AG value is set to 4×, and the DG value is set to 1×. It is to be understood that the preset values may be appropriately set according to the actual needs and the accumulated experience value, and are not limited to the value defined in the disclosed embodiment. For some image sensors, the applicants have found that the FPN of the image sensor does not change significantly with the change of the operating parameters of the image sensor, so the operating parameters of an image sensor may be set more flexibly.

It is to be understood that, in some embodiments, prior to performing Step 201, the method further includes determining that there is no valid FPN calibration data. For example, the noise reduction circuit 12 or the image processor 14 first reads the data in the storage unit of the noise reduction circuit 12, to determine whether there is valid FPN calibration data. If there is no valid FPN calibration data, then Step 201 is performed. Determining whether there is valid FPN calibration data includes determining whether there is FPN calibration data in the noise reduction circuit and determining whether the FPN calibration data is successfully verified. If the FPN calibration data exists in the noise reduction circuit and the FPN calibration is successfully verified, it is determined that there is valid FPN calibration data in the storage unit of the noise reduction circuit. The FPN calibration data being 0 or null or a default value indicates that there is no FPN calibration data in the storage unit of the noise reduction circuit.

Next, the raw image data is acquired. The image sensor 10 is controlled to acquire at least one frame of raw image data. The raw image data may be raw data obtained by analog-to-digital conversion of a voltage or current signal collected by the image sensor 10. In some embodiments, a frame of raw image data is pixel values arranged in rows and columns (as shown in FIG. 3). The raw image data shown in FIG. 3 is raw image data of the RGB Bayer domain. It is to be understood that, in some embodiments, the raw image data may also be data in other formats.

Step 202: Determine the FPN calibration data of the image sensor based on the raw image data. In some embodiments, the generation of the FPN calibration data may be performed on an external processing device (e.g., a PC or other types of computing device) having data processing capabilities. The raw image data is output to the processing device, and the FPN calibration data is generated by an FPN calibration instruction set running on the processing device.

Here, the quantity of the raw image data is at least one frame, and determining the FPN calibration data of the image sensor based on the raw image data output by the image sensitive unit array includes:

determining FPN calibration data for each frame based on each frame of raw image data output by the image sensitive unit array; averaging FPN calibration data of each frame to obtain the FPN calibration data of the image sensor; where the averaging includes, but is not limited to, getting an arithmetic mean, geometric mean, squared average, harmonic mean or weighted average, etc.

Alternatively, the FPN calibration data of the image sensor is determined based on an average of at least one frame of raw image data output by the image sensitive unit array.

Here, determining the FPN calibration data of the image sensor includes determining the FPN calibration data of each image sensitive unit based on the raw image data output by the image sensitive unit array. In some embodiments, the FPN calibration data for each image sensitive unit is used as the FPN calibration data of the image sensor. In some embodiments, among the FPN data of each of the image sensitive units, only FPN data greater than a threshold is used as the FPN calibration data of the image sensor. The FPN calibration data of the image sensor whose noise is less than the threshold is 0, null or a default value.

Further, determining the FPN calibration data of the image sensor based on the raw image data includes:

Acquiring the dark current correction value of the image sensitive unit array. The dark current correction value is also referred to as an OB value, which is data output by the image sensor due to the presence of dark current under optical black conditions. This data is related to the image sensor itself, is a constant value, and usually has been measured and provided by the manufacturer when the image sensor is shipped from the manufacturer.

Determining the FPN calibration data of the image sensor based on the raw image data output by the image sensitive unit array and the dark current correction value of the image sensitive unit array. The FPN calibration data of the image sensor is a value with the dark current correction value being removed.

The output raw image data contains the dark current correction value and the FPN calibration data. The dark current correction value (i.e., OB value) of the image sensor is generally left for correction by the image processor. That is, the OB value is removed in the image processor. Optionally, in some embodiments, the calibration data may also optionally include both the OB value and the FPN, and the OB value is not required to be removed by the image processor.

In the following, specific details are provided by taking one frame of raw image data as an example, where the FPN calibration data of each image sensitive unit is used as the FPN calibration data of the image sensor.

The schematic diagram of generating the FPN calibration data is shown in FIG. 3.

Assuming that the resolution of the image processing apparatus 1 is n*m (n, m is a positive integer greater than 1), the resulting raw data arrangement is as shown in the left box of FIG. 3 The pixels of the raw data are arranged in a matrix of 2n*m in the form of Grᵢⱼ, Rᵢⱼ, Bᵢⱼ, Gbᵢⱼ, (i=1, 2, 3, . . . , n; j=1, 2, 3, . . . , m) (each pixel array corresponds to an image sensitive unit), and the pixel array is a Bayer pattern.

The number of FPN calibration data may be equal to or smaller than the number of the image sensitive units. For example, when the number of FPN calibration data is consistent with the number of the image sensitive units, the rule for generating FPN calibration data may be:

FGrᵢⱼ=OB−Grᵢⱼ

FGbᵢⱼ=OB−Gbᵢⱼ

FRⱼ=OB−Rᵢⱼ

FBⱼ=OB−Bᵢⱼ

where, FGrᵢⱼ, FGbᵢⱼ, FRⱼ, FBⱼ are calibration data.

The applicants have found that the FPN of the conventional image sensors appears as a vertical stripe, and the offset values of each column are almost the same. Therefore, in the disclosed embodiment, the FPN calibration data is generated by the rule: for one column of image sensitive units in the image sensitive unit array, determining the FPN calibration data of the column of image sensitive units based on the raw image data output by the column of image sensitive units, and the FPN calibration data of the column of image sensitive units is used for noise reduction for the column of image sensitive units. It is to be understood that, in some embodiments, if the FPN appears as a horizontal stripe, the FPN calibration data of one row of image sensitive units may be determined based on the raw image data output by the row of image sensitive units, and the FPN calibration data of the row of image sensitive units is used for noise reduction for the row of image sensitive units.

In some embodiments, the image sensitive units in the column are configured to output image data of a class of M-channel, and the FPN calibration data of the column of image sensitive units includes FPN calibration data of the class of M-channel. In the embodiment described above, the raw image data includes one blue channel (Bᵢⱼ), one red channel (Rᵢⱼ), and two green channels (Grᵢⱼ, Gbᵢⱼ). The FPN calibration data includes calibration data of four channels (Grⱼ, Gbⱼ, Rⱼ, Bⱼ).

In the present disclosure, the number of FPN calibration data of a column of image sensitive units is less than the number of image sensitive units in the column. Accordingly, the number of FPN calibration data corresponding to each class of channel is smaller than the number of image sensitive units corresponding to that class of channel. This may reduce the data storage of the FPN calibration data, simplify the calibration process and noise reduction process. In some embodiments, the image sensitive units in the column are configured to output image data of a class of M-channel, and the number of FPN calibration data of the column of image sensitive units is M.

In the embodiment shown in FIG. 3, the rule of generating the FPN calibration data may be:

Grⱼ=OB−Avg(Gr₁ⱼ:Grₙⱼ)

Gbⱼ=OB−Avg(Gb₁ⱼ:Gbₙⱼ)

Rⱼ=OB−Avg(R₁ⱼ:Rₙⱼ)

Bⱼ=OB−Avg(B₁ⱼ:Bₙⱼ)

where j is the column number, Avg(a₁: aₛ) is an averaging function defined as

$$Avg ( {a}_{1} \text{:} {a}_{s} ) = \frac{1}{s} {\sum }_{r = 1}^{s} {a}_{r} , r = 1 , 2 , … , s$$

For example, for Avg (Gr₁ⱼ: Grₙⱼ), the calculation is

$$Avg ( {Gr}_{1 j} \text{:} {Gr}_{nj} ) = \frac{1}{n} {\sum }_{i = 1}^{n} {Gr}_{ij} , i = 1 , 2 , … , n$$

which means that it is to take the average value of the Gr pixels in a certain column of pixels.

The FPN calibration data generated according to the above rules is a 2*m array, and its size is 2*m bytes, as shown in the box in the upper right corner of FIG. 3. The FPN calibration data corresponding to each pixel is the difference between the OB value and the average value of the pixels on the column.

The FPN calibration data is an array of 2*m. For a column of image sensitive units, the number of image sensitive units is 4n, and there are only four FPN calibration data, that is, one FPN calibration data for each channel.

It is to be understood that if the FPN noise difference among the same column of image sensitive units is large, the same column of image sensitive units may be divided into blocks, and the FPN calibration data is respectively calculated for each block.

For example, the image is divided into upper and lower blocks. For each of the upper and lower blocks, a 2*m array is calculated. The pixel compensation of the upper and lower blocks is respectively determined according to the corresponding calibration data array. The determination rule may be:

The pixel array is a Bayer Pattern Grᵢⱼ, Rᵢⱼ, Bᵢⱼ, Gbᵢⱼ, where i=1, 2, 3, . . . , n; j=1, 2, 3, . . . , m. The pixel array is divided into N number of pixel array sub-regions (each pixel array sub-region corresponds to one image block). The starting row and the ending row of each pixel array sub-region are respectively s, t, where N is greater than or equal to 2, s is a positive integer greater than or equal to 1, and t is a positive integer greater than or equal to 2.

The FPN calibration data is N number of m*2 arrays Grⱼ, Rⱼ, Bⱼ, Gbⱼ, and the determination rule is:

Grⱼ=OB−Avg(Grₛⱼ:Grₜⱼ);

Gbⱼ=OB−Avg(Gbₛⱼ:Gbₜⱼ);

Rⱼ=OB−Avg(Rsⱼ:Rtⱼ);

Bⱼ=OB−Avg (Bsⱼ:Btⱼ).

It is to be understood that, in some embodiments, in order to simplify the calculation, the channel (i.e., Gr, R, B, Gb, etc.) may be ignored, and an array of 1*m is calculated. If calculated this way, the FPN data of different channels is the same. At this moment, for a column of image sensitive units, the number of FPN calibration data is one. The determination rule may be: the pixel array is a Bayer Pattern Grᵢⱼ, Rᵢⱼ, Bᵢⱼ, Gbᵢⱼ, where i=1, 2, 3, . . . , n; j=1, 2, 3, . . . , m;

The FPN calibration data is a row of data Fⱼ, and the determination rule is:

Fⱼ=OB−Avg (Gr₁ⱼ:Grₙⱼ, Gb₁ⱼ:Gbₙⱼ, R₁ⱼ:Rₙⱼ, B₁ⱼ:Bₙⱼ).

Step 203: Store the FPN calibration data to a predetermined storage. In the disclosed embodiment, the FPN calibration data is stored in a storage unit of the internal noise reduction module of the image processing apparatus. The noise reduction module is the image sensor 10, the image processor 14, or the noise reduction circuit 12 coupled to the image sensor. If stored in the storage unit of the noise reduction circuit 12, the FPN calibration data and the check data may be first transmitted to the image processor 14. The image processor 14 may then store the FPN calibration data and the check data in the storage unit of the noise reduction circuit 12.

Further, in some embodiments, the FPN calibration method further includes: generating check data according to the FPN calibration data, and saving the check data of the FPN calibration data to a predetermined storage. The FPN check data is generated based on the FPN calibration data, and is a check value calculated for the raw data by a specified algorithm, to protect the integrity of the data. When the receiving entity uses the same algorithm to calculate the check value again, if the two check values are the same, it means that the data is a data of integrity. The check data may be generated by various proper check data algorithms, such as parity check, BCC (block check character), LRC (longitudinal redundancy check), CRC (cyclic redundancy check), MD5 (message-digest algorithm 5), SHA (secure hash algorithm 1), MAC (message authentication code), and other digest algorithms. In the present embodiment, the check data is generated by using a CRC algorithm, and the obtained check data of the FPN calibration data is CRC data.

Further, in some embodiments, the FPN calibration method further includes: verifying whether the FPN calibration data stored in the preset storage remains its integrity. The verification may be implemented in the processing apparatus. The processing apparatus reads the FPN calibration data from the storage unit of the noise reduction circuit 12 through the image processor 14, and then calculates the check value by using the same algorithm as calculating the check data in the storage unit. If the check value is consistent with the check data of the FPN calibration data stored in the storage unit, it indicates that the FPN calibration data stored in the storage unit of the noise reduction circuit 12 is completely stored.

It is to be understood that the FPN calibration data may be generated before the image processing apparatus 1 is shipped from the manufacturer and stored in the noise reduction circuit 12, or may be generated when the image processing apparatus 1 is run for the first time. The generation of the FPN calibration data may be performed in any processing device having data processing capabilities. The processing device includes a processor capable of executing a predetermined set of computer readable instructions to implement the image noise calibration method. The processor may generate the FPN calibration data according to the rule of generating the FPN calibration data described above when the processor executes the computer readable instruction set.

The image noise reduction method according to the present disclosure calculates compensation data of the raw image data according to the pre-stored FPN calibration data of the image sensor 10 and the raw image data output by the image sensor 10, and compensates the raw image data according to the compensation data, to achieve noise reduction.

In some embodiments, the FPN calibration data of the image sensor is pre-stored in a storage unit of an internal noise reduction module of the image processing apparatus. The image noise reduction method is applied to the noise reduction module. The noise reduction module is the image sensor 10, or the image processor 14, or the noise reduction circuit 12 connected to the image sensor. For example, in some embodiments, the FPN calibration data of the image sensor 10 is stored in a storage unit of the noise reduction circuit 12, and the image noise reduction method is performed by the noise reduction circuit 12. In some embodiments, the FPN calibration data of the image sensor 10 is stored in a noise reduction module of the image sensor 10, and the image noise reduction method is performed by the noise reduction module in the image sensor. At this time, it is not necessary to include a noise reduction circuit 12, and the image sensor 10 is directly connected to the image processor 14, and outputs image data to the image processor 14 after the noise reduction. In some embodiments, the FPN calibration data of the image sensor 10 is stored in the image processor, the image noise reduction method is performed by the image processor. At this time, it is not necessary to include a noise reduction circuit 12, and the image sensor 10 is directly connected to the image processor 14.

Here, the image noise reduction method is performed when it is determined that the exposure information corresponding to the raw image data satisfies a predetermined condition, and/or when it is determined that the FPN calibration data of the image sensor is successfully verified.

The exposure information includes an exposure gain. The exposure gain is determined based on a product of the AG and the DG. When the exposure gain corresponding to the raw image data is not less than the exposure gain corresponding to the FPN calibration data, it is determined that the exposure information corresponding to the raw image data satisfies a predetermined condition.

Performing verification on the FPN calibration data of the image sensor includes: calculating check data according to the pre-stored FPN calibration data, if the calculated check data is consistent with the pre-stored check data, determining that the FPN calibration data is valid, that is, determining that the FPN calibration data of the image sensor is successfully verified.

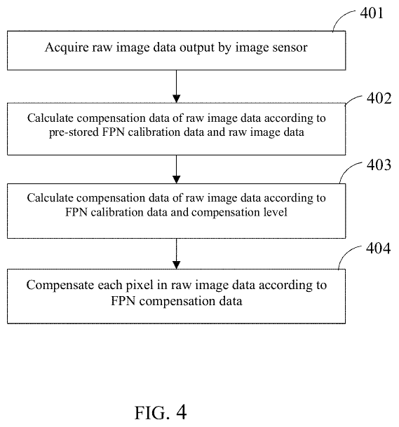

FIG. 4 is a flowchart of an image noise reduction method according to an embodiment of the present disclosure. In the figure, the FPN calibration data of the image sensor 10 is stored in a storage unit of the noise reduction circuit 12, and the image noise reduction method is performed by the noise reduction circuit 12. When the image processor 14 determines that the exposure information corresponding to the raw image data satisfies a predetermined condition, and/or determines that the FPN calibration data in the storage unit of the noise reduction circuit 12 is successfully verified, the noise reduction circuit performs the image noise reduction method based on the enablement by the image processor 14.

The image processor 14 reads exposure information of the image sensor 10 from the image sensor 10. In some embodiments, the exposure information of the image sensor 10 includes, but is not limited to, an exposure gain, an exposure time, an exposure amount, and the like. The exposure gain includes an AG, a DG, and the exposure gain is determined based on the AG and the DG. The calculation method may be a conventional calculation method such as addition, multiplication, or weighted averaging. The specific calculation method may also be obtained based on the deduction of the experimental data. In some embodiments, the exposure gain is determined by a product of the AG and the DG. When the exposure gain corresponding to the raw image data is not less than the exposure gain corresponding to the FPN calibration data, it is determined that the exposure information corresponding to the raw image data satisfies a predetermined condition. For example, the exposure gain is determined to be 4× when determining the FPN calibration data. If the exposure gain of the raw image data is not less than 4×, the adaptive denoising function of the noise reduction circuit 12 is determined to be enabled. In some embodiments, whether the adaptive denoising function should be enabled may also be determined based on parameter values such as the exposure amount. For example, if the exposure amount is lower than a preset value, the adaptive denoising function is enabled.

The check data of the image sensor is also stored in advance in the storage unit of the noise reduction circuit. When verifying the FPN calibration data in the storage unit of the noise reduction circuit 12, the image processor 14 reads the FPN calibration data from the storage unit of the noise reduction circuit, and calculates its check data based on the read FPN calibration data. When the calculated check data is consistent with the check data stored in the storage unit of the noise reduction circuit, the FPN calibration data is determined to be verified. If the calculated check data does not match the check data stored in the storage unit of the noise reduction circuit, the adaptive noise reduction function of the noise reduction circuit 12 is disabled. In some embodiments, after the disablement, a user may be prompted to ask whether the FPN calibration data should be generated. If the user determines that the FPN calibration data should be generated, the image noise calibration method described in FIG. 2 is enabled.

Step 401: Acquire raw image data output by the image sensor.

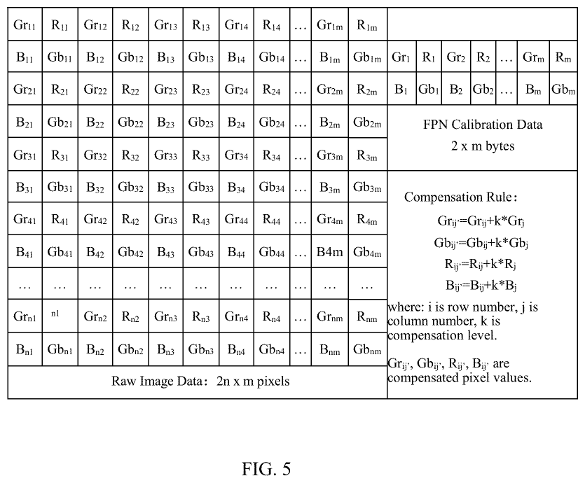

The image sensor 10 includes an image sensitive unit array. The raw image data is output by the image sensitive unit array in normal operations. The image sensor 10 is controlled to acquire at least one frame of raw image data. The raw image data may be digital raw data obtained by analog-to-digital conversion of a voltage or current signal collected by the image sensor 10. In some embodiments, each frame of raw image data is pixel values arranged in rows and columns (as shown in FIG. 5). The raw image data shown in FIG. 5 is raw image data of the RGB Bayer domain. It is to be understood that, in some embodiments, the raw image data may also be data of other formats, such as data in Ycbcr format.

Step 402: Calculate compensation data of the raw image data according to the pre-stored FPN calibration data of the image sensor and the raw image data.

Here, the calculation of the compensation data of the raw image data according to the pre-stored FPN calibration data of the image sensor and the raw image data includes: acquiring a compensation level; and calculating the compensation data of the raw image data based on the FPN calibration data and the compensation level. It is to be understood that, in some embodiments, the compensation data may also be determined directly based on the FPN calibration data without calculating a compensation level. For example, when an image sensor does not change much under different conditions (e.g., different exposure gains or different temperatures), the compensation data may be determined directly based on the FPN calibration data without calculating a compensation level. For example, the compensation data is calculated by arithmetically calculating (e.g., addition, subtraction, etc.) using the raw image data and the FPN calibration data.

The compensation level is determined based on the exposure information corresponding to the FPN calibration data of the image sensor and the exposure information corresponding to the raw image data, and/or determined based on the temperature information corresponding to the FPN calibration data of the image sensor and the temperature information corresponding to the raw image data.

Here, the compensation level value is positively correlated with the value of exposure gain. The greater the exposure gain, the greater the compensation level. In actual operations, a variation curve between the compensation level K value and the exposure gain value (e.g., a linear curve or an exponential curve or other function curves) may be fitted by using the historical data. The compensation level K value is then obtained according to the curve and the value of exposure gain. In addition, it is also possible to determine the compensation level K values corresponding to different exposure gain values based on an interpolation table obtained in advance. Typically, the noise introduced by the AG will be slightly smaller. Therefore, in some embodiments, the compensation level K value is determined based on the DG. Accordingly, the compensation level K value is positively correlated with the DG. The larger the DG, the larger the compensation level K. In some embodiments, the compensation level K value is the same as the DG. For example, when the DG is 1×, the compensation level K is 1. In actual operations, the variation curve between the compensation level K value and the DG value may be fitted based on the historical data, and then the compensation level K value is obtained according to the variation curve and the DG value.

In the adaptive denoising state, the AE mode of the image sensor 10 is set to an automatic mode. Therefore, during the operation of the image sensor 10, the AG and the DG of the image sensor 10 are changing. The image processor 14 determines the compensation level K value of each frame of image based on the AG and DG acquired in real-time, and transmits the compensation level K value of each frame according to a frame rate of the image sensor 10.

The image processor 14 sends the compensation level K value to the noise reduction circuit 12. In some embodiments, the image processor 14 transmits one compensation level K value per frame to the noise reduction circuit 12 according to a frame rate of the image sensor 10.

The noise reduction circuit receives the compensation level K value transmitted from the image processor 14, and calculates the compensation data of the raw image data based on the FPN calibration data and the compensation level.

Step 403: The noise reduction circuit 12 receives the compensation level K value transmitted from the image processor 14, and calculates the compensation data of the raw image data based on the FPN calibration data and the compensation level K. In some embodiments, the compensation data is calculated based on a product of the FPN calibration data and the compensation level K.

In the noise reduction method of the present disclosure, the number of the FPN calibration data is smaller than the number of the image sensing units in the image sensitive unit array of the image sensor.

When calculating the compensation data, for one column of image sensitive units in the image sensitive unit array, the compensation data of the raw image data output by the column of the image sensitive units is calculated based on the FPN calibration data of the column of the image sensitive units. Here, the number of FPN calibration data of the column of image sensitive units is smaller than the number of image sensitive units in the column of image sensitive units.

In some embodiments, the image sensitive units in the column are configured to output image data of a class of M-channel, and the FPN calibration data of the column of the image sensitive units includes FPN calibration data of the class of M-channel. The number of the FPN calibration data corresponding to each class of channel is smaller than the number of image sensitive units corresponding to that class of channel. This may reduce the amount of data storage for the FPN calibration data, simplify the calibration process and noise reduction process.

In some embodiments, image sensitive units in one column configured to output image data of a class of M-channel, and the number of FPN calibration data of the column of image sensitive units is M. Calculating the compensation data of the raw image data according to the pre-stored FPN calibration data of the image sensor includes: respectively calculating, according to M number of FPN calibration data, the compensation data of the image data of the M-channel in the column of the image sensitive units, where each FPN calibration data is used to calculate the compensation data for all image data in a class of channel. As shown in FIG. 5, the raw image data includes a blue channel (Bᵢⱼ), a red channel (Rᵢⱼ), and two green channels (Grᵢⱼ, Gbᵢⱼ). The FPN calibration data includes four channels of calibration data (Grⱼ, Gbⱼ, Rⱼ, Bⱼ). The FPN calibration data is an array of 2*m. For a column of image sensitive units, the number of image sensitive units is 4n, and the number of FPN calibration data is four, that is, one FPN calibration data for each class of channel.

In some embodiments, the FPN calibration data of the image sensor is FPN calibration data of a portion of the image sensitive units in the image sensitive unit array, and each FPN calibration data is used to calculate the compensation data of the raw image data output by an image sensitive unit corresponding to the FPN calibration data. For example, in the FPN calibration process of the image noise, for a pixel unit whose FPN calibration data is smaller than a preset threshold, the FPN calibration data is not used as the FPN calibration data of the image sensor 10. Only the FPN calibration data of a pixel unit whose FPN calibration data reaches a preset threshold can be used as the FPN calibration data of the image sensor 10. At this moment, when the compensation data is calculated for the raw image data, the compensation data is calculated only for the pixel units whose FPN calibration data reaches the preset threshold.

Step 404: The noise reduction circuit 12 compensates each pixel in the raw image data according to the compensation data. The compensated image data is output to the image processor 14 for further image processing. The image processing includes, but is not limited to, data compression and back-end interface control, data transmission, control, image preview, lens focus control, and interface usage, etc.

Compensating the raw image data according to the compensation data includes: adding or subtracting the compensation data from the raw image data.

Refer to FIG. 5 for specific rules for FPN compensation data generation and pixel compensation.

The left box of FIG. 5 shows a pixel array of the raw image data (each pixel corresponds to an image sensitive unit of the image sensor), and the box in the upper right corner shows the FPN calibration data, while the box in the lower right corner is the compensation rule. Here, the compensation data is the product of K and the corresponding calibration data, and the compensated pixel value is the sum of the original pixel value and the compensation data.

Specifically, the compensation rule is as follows:

Grᵢⱼ′=Grᵢⱼ+k*Grⱼ

Gbᵢⱼ′=Gbᵢⱼ+k*Gbⱼ

Rᵢⱼ′=Rᵢⱼ+k*Rⱼ

Bᵢⱼ′=Bᵢⱼ+k*Bⱼ

where: i is the row number, j is the column number, and k is the compensation level; Grᵢⱼ, Gbᵢⱼ, Rᵢⱼ, Bᵢⱼ are pixel values originally sensed; and Grᵢⱼ′, Gbᵢⱼ′, Rᵢⱼ′, Bᵢⱼ′ are compensated pixel values.

It is to be understood that, before Step 401, a process for setting the image sensor 10 may be further included. During the setting, the working mode of the image sensor 10 may be manually or automatically set to a normal working mode, the AE mode of the image sensor is an automatic mode in which the analog gain and digital gain are automatically adjusted with the shooting environment.

In order to simplify the calculation of the noise reduction circuit 12, the compensation rule for the pixels in the above embodiment is achieved by simple addition and multiplication. It is to be understood that other functions based on K and FPN calibration data may also be used to determine the compensated pixel value. It may be appreciated that in some embodiments, other algorithms may be applied to compensate for pixels of the raw image data. The effect of noise caused by temperature changes of the sensor may also be considered, where the effect of temperature on noise may be determined by a temperature-noise curve or an interpolation table.

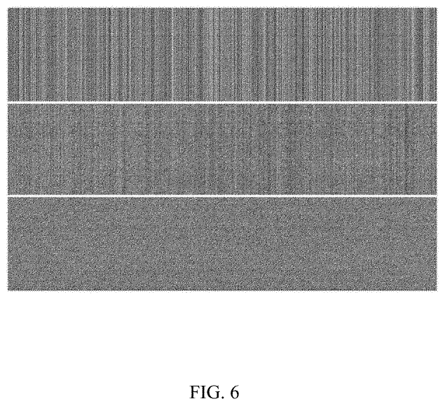

Referring to FIG. 6, a comparison chart before and after correction is provided. The uppermost one is uncorrected. The middle is the effect of on-chip noise reduction of an image sensor. The bottom is the effect of noise reduction by using the noise reduction method described in the present disclosure. Clearly, the noise reduction method described in the present disclosure is more effective.

From FIG. 5 and the above compensation rule, it can be seen that the compensation data for the pixels in the same column is the same. In some embodiments, the FPN calibration data is a row of data. Therefore, in processing, the pixel data is processed row by row, and thus it is a row-level cache. The row-level cache is mainly a mode in which the storage corresponding to the image processing is read row by row. The traditional noise reduction method requires all pixel data of a frame to be processed, and thus it is a frame-level cache. The noise reduction method described in the present disclosure adopts a row-level cache, and the pixel-level processing delay may allow FPN noise reduction processing to be performed in real time without using frame-level cache and frame-level delay for FPN noise reduction like other existing solutions. Therefore, it works well for imaging systems that require real-time processing and high image quality, such as first-person view wireless image transmission devices.

In some embodiments, the noise reduction method provided by the present disclosure may analyze the collected relevant data information by collecting the raw image data sent by the image sensor 10, calculate the compensation level K value in real time based on the collected data information, and feeds it back to the noise reduction circuit 12 in real-time, thereby achieving adaptive noise reduction in real-time.

In some embodiments, the FPN noise reduction introduced by the noise reduction method of the present disclosure is interposed between the image sensor and the back-end image signal processor, which solves the problem that the image sensor and the back-end image processor do not have the FPN noise reduction. At the same time, the noise reduction method provided by the present disclosure works in the raw image data (e.g., Bayer Raw) domain, which does not disturb the existing image signal processing process, and avoids the trouble of complicated post-processing denoising. In addition, the FPN calibration data fits perfectly with the image sensor's Bayer pattern and data memory arrangement, eliminating the need for frame caching and data reordering throughout the process.

In some embodiments, the noise reduction method shown in the present disclosure performs off-chip noise reduction, avoids the requirements for special hardware circuits and memory cells for on-chip noise reduction. In addition, by using the noise reduction circuit 12 to implement adaptive noise reduction, the implementation is more flexible and convenient.

In some embodiments, by using the computing resources and storage space of the noise reduction circuit 12 combined with the software intelligent configuration, the noise reduction method shown in the present disclosure may automatically turn on or turn off the FPN noise reduction function according to ambient light without requiring user intervention, which is more intelligent and has more practical applications.

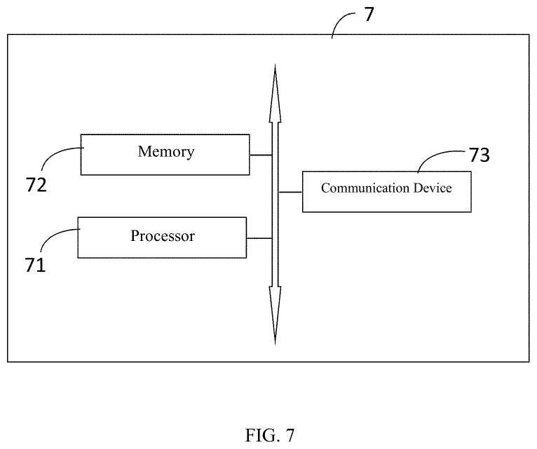

Referring to FIG. 7, a schematic structural diagram of an image noise calibration apparatus is provided. The image noise calibration apparatus 7 includes a processor 71, a memory 72, and a communication device 73.

The memory 72 may be configured to store computer programs and/or modules or computer readable instruction sets. The processor 71 implements the image noise calibration (e.g., the image noise calibration method shown in FIG. 2) by running or executing the computer programs and/or modules or computer readable instruction sets stored in the memory 72. The memory 72 may mainly include a program storage area and a data storage area. The program storage area may store an operating system, an application required for at least one function (e.g., an audio and video playback function), and the like. The data storage area may store data created by the operation of the image noise calibration apparatus 7 and the like. In addition, the memory 72 may include a high-speed random-access memory, and may also include a non-volatile memory such as a hard drive, a memory, a plug-in hard disk, a smart media card (SMC), and a secure digital (SD) card, a flash card, at least one disk storage device, a flash drive, or other volatile solid-state storage devices.

The processor 71 may be a CPU, or may be another general-purpose processor, a DSP, an ASIC, an FPGA or other programmable logic devices, discrete gate or transistor logic device, discrete hardware components, etc. The general-purpose processor may be a microprocessor or any conventional processor or the like. The processor 71 is a control center of the image noise calibration apparatus 7, and is connected to the various parts of the image noise calibration apparatus 7 by using various interfaces and lines.

The image noise calibration apparatus 7 further includes at least one communication device 73.

The communication device 73 may be a wired or wireless communication device. A wired communication device includes a communication port, such as a universal serial bus (USB), a controller area network (CAN), a serial and/or other standard network connection, and an integrated circuit (inter-integrated circuit, I2C) bus, etc. A wireless communication device may employ any type of wireless communication system, such as Bluetooth, infrared, wireless fidelity (WiFi), cellular technology, satellite, and broadcast. The cellular technology may include mobile communication technologies such as second generation (2G), third generation (3G), fourth generation (4G) or fifth generation (5G).

It will be understood by those skilled in the art that the schematic diagram is only an example of the image noise calibration apparatus 7, and does not constitute a limitation on the image noise calibration apparatus 7. The image noise calibration apparatus 7 may include more or fewer components, or a combination of certain components, or include different components. For example, according to actual needs, the image noise calibration apparatus 7 may also include an input/output device, a display device, and the like. The input and output device may include any suitable input device including, but not limited to, a mouse, a keyboard, a touch screen, or a contactless input, such as gesture input, voice input, and the like. The display device may be a liquid crystal display (LCD), a light emitting diode (LED) display, an organic light-emitting diode (OLED) or other proper display.

The processor 71 executes the computer programs and/or modules or computer readable instruction sets to implement:

acquiring raw image data output by the image sensor, where the image sensor includes an image sensitive unit array, and the raw image data is output by the image sensitive unit array in an optical black state;

determining FPN calibration data of the image sensor based on the raw image data output by the image sensitive unit array, where the FPN calibration data is used for noise reduction of the image sensitive unit array, and the number of the FPN calibration data is less than the number of image sensitive units in the image sensor.

Determining the FPN calibration data of the image sensor based on the raw image data output by the image sensing unit array includes:

for one column of image sensitive units in the image sensitive unit array, determining FPN calibration data of the column of image sensitive units based on raw image data output by the column of image sensitive units, where the FPN calibration data of the column of image sensitive units is used for noise reduction of the column of image sensitive units, and the number of FPN calibration data of the column of image sensitive units is less than the number of image sensitive units in the column.

In some embodiments, the image sensitive units in the column are configured to output image data of a class of M-channel, the FPN calibration data of the column of image sensitive units includes FPN calibration data of the class of M-channel, and the number the FPN calibration data corresponding to each class of channel is smaller than the number of image sensitive units corresponding to that class of channel.

In some embodiments, the raw image data is image data of a Bayer domain.

In some embodiments, the image sensitive units in the column are configured to output image data of a class of M-channel, and the number of FPN calibration data of the column of image sensitive units is M.

In some embodiments, the raw image data is image data of an RGB Bayer domain, and the class of M-channel includes a blue channel, a red channel, and two green channels.

In some embodiments, the number of FPN calibration data for the column of image sensitive units is one.

In some embodiments, determining the FPN calibration data of the image sensor based on the raw image data output by the image sensitive unit array includes:

determining FPN data of each image sensitive unit based on raw image data output by the image sensitive unit array; and

among the FPN data of each of the image sensitive units, FPN data larger than a threshold is used as the FPN calibration data of the image sensor.

In some embodiments, the processor executing the set of computer readable instructions further implements:

obtaining a dark current correction value of the image sensitive unit array; and

determining the FPN calibration data of the image sensor based on the raw image data output by the image sensing unit array includes:

determining the FPN calibration data of the image sensor based on the raw image data output by the image sensitive unit array and the dark current correction value of the image sensitive unit array, where the FPN calibration data of the image sensor is a value with the dark current correction value being removed.

In some embodiments, the quantity of the raw image data is at least one frame, and determining the FPN calibration data of the image sensor based on the raw image data output by the image sensing unit array includes:

determining FPN calibration data for each frame based on each frame of raw image data output by the image sensitive unit array, and averaging the FPN calibration data of each frame to obtain the FPN calibration data of the image sensor; or,

determining the FPN calibration data of the image sensor based on an average of at least one frame of raw image data output by the image sensitive unit array.

In some embodiments, the image noise calibration apparatus 7 also stores the FPN calibration data of the image sensor into a storage unit of the noise reduction module.

In some embodiments, the noise reduction module is an image sensor, an image processor, or a noise reduction circuit connected to the image sensor.

In some embodiments, the image noise calibration apparatus is further configured to generate check data according to the FPN calibration data, and store the FPN calibration data and the check data in the storage unit of the noise reduction module.

In some embodiments, the check data is generated using a CRC algorithm.

In some embodiments, the image noise calibration apparatus is further configured to verify the FPN calibration data based on the check data.

In some embodiments, the image noise calibration apparatus is further configured to: determine that no valid FPN calibration data is stored in the image sensitive unit array. The method for determining that no valid FPN calibration data is not stored in the image sensitive unit array includes: reading data in the storage unit, and if there is no FPN calibration data or the FPN calibration data fails to be verified, determining that no valid FPN calibration data is stored in the image sensitive unit array.

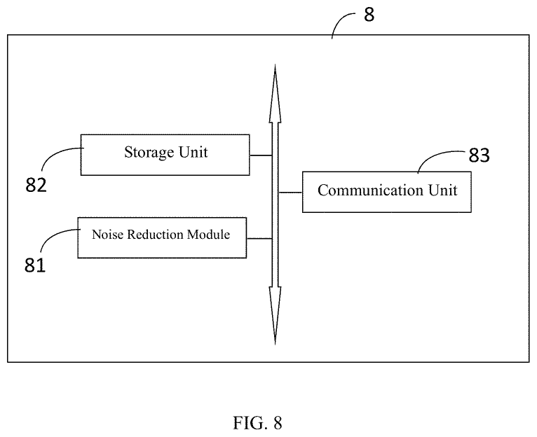

FIG. 8 is a schematic structural diagram of an image noise reduction apparatus 8 according to an embodiment of the present disclosure. The image noise reduction apparatus 8 is communicatively coupled to the image sensor for performing noise reduction processing on the raw image data output by the image sensor.

The image noise reduction apparatus 8 includes a noise reduction module 81, a storage unit 82, and a communication unit 83. The storage unit 82 is configured to pre-store FPN calibration data of the image sensor. The noise reduction module 81 is configured to perform noise reduction processing on the raw image data output by the image sensor based on the FPN calibration data. The communication unit 83 is configured to communicate with the image sensor. The storage unit 82 and the communication unit 83 are similar to the memory 72 and the communication device 73 of the image noise calibration apparatus 7. The foregoing descriptions for the memory 72 and the communication device 73 of the image noise calibration apparatuses 7 are also applicable to the storage unit 82 and the communication unit 83, details of which will not be repeated again here.

The noise reduction process includes:

obtaining raw image data output by the image sensor;

calculating compensation data of the raw image data according to pre-stored FPN calibration data of the image sensor; and

compensating the raw image data based on the compensation data.

In some embodiments, calculating the compensation data of the raw image data according to the pre-stored FPN calibration data of the image sensor and the raw image data includes:

obtaining a compensation level; and

calculating the compensating data of the raw image data based on the FPN calibration data and the compensation level.

In some embodiments, the noise reduction process is performed when it is determined that exposure information corresponding to the raw image data satisfies a predetermined condition, and/or when it is determined that the FPN calibration data of the image sensor is successfully verified.

In some embodiments, the exposure information includes an exposure gain.

In some embodiments, the compensation level is positively correlated with the exposure gain, the greater the exposure gain, the greater the compensation level.

In some embodiments, when the exposure gain corresponding to the raw image data is not less than the exposure gain corresponding to the FPN calibration data, it is determined that the exposure information corresponding to the raw image data satisfies a predetermined condition.

In some embodiments, the exposure gain is determined based on a product of analog gain and digital gain.

In some embodiments, the FPN calibration data of the image sensor is pre-stored in the storage unit of the noise reduction module.

In some embodiments, the noise reduction module is an image sensor, an image processor, or a noise reduction circuit connected to the image sensor.

In some embodiments, the noise reduction module is a noise reduction circuit which is connected to the image processor; and

when the image processor determines that the exposure information corresponding to the raw image data satisfies a predetermined condition, and/or determines that the FPN calibration data of the image sensitive unit array is successfully verified, the noise reduction circuit performs the noise reduction process based on the enablement from the image processor.

In some embodiments, the noise reduction circuit further stores check data of the image sensor in advance; and

the noise reduction process further includes that:

the noise reduction circuit transmits the FPN calibration data and the check data of the image sensor to the image processor, to allow the image processor to perform verification on the FPN calibration data of the image sensor.

In some embodiments, the noise reduction module is in a noise reduction circuit, and the noise reduction process further includes that:

the noise reduction circuit receives a compensation level transmitted from the image processor; and

the noise reduction circuit calculates the compensation data of the raw image data based on the FPN calibration data and the compensation level from the image processor.

In some embodiments, the compensation level is determined based on exposure information corresponding to the FPN calibration data of the image sensor and exposure information corresponding to the raw image data, and/or based on temperature information corresponding to the FPN calibration data of the image sensor and temperature information corresponding to the raw image data.

In some embodiments, the compensation data is calculated based on a product of the FPN calibration data and the compensation level.

In some embodiments, the image sensor includes an image sensitive unit array, and the number of FPN calibration data is less than the number of image sensitive units in the image sensitive unit array.

In some embodiments, calculating the compensation data of the raw image data according to the pre-stored FPN calibration data of the image sensor includes:

for one column of image sensitive units in the image sensitive unit array, calculating the compensation data of the raw image data output by the column of image sensitive units based on the FPN calibration data of the column of image sensitive units, where the number of FPN calibration data of the column of image sensitive units is smaller than the number of image sensitive units in the column of image sensitive units.

In some embodiments, the raw image data is image data of a Bayer domain.

In some embodiments, the image sensitive units in the column are configured to output image data of a class of M-channel, and the FPN calibration data of the column of image sensitive units includes FPN calibration data of the class of M-channel, and the number of the FPN calibration data corresponding to each class of channel is smaller than the number of image sensitive units corresponding to that class of channel.

In some embodiments, the image sensitive units in the column are configured to output image data of the class of M-channel, and the number of the FPN calibration data of the column of the image sensitive units is M; and

calculating the compensation data of the raw image data according to the pre-stored FPN calibration data of the image sensor includes:

respectively calculating the compensating data of image data of the class of M-channel in the column of image sensitive units according to M number of FPN calibration data, where each FPN calibration data is used to calculate compensation data of all image data in one class of channel.

In some embodiments, the FPN calibration data of the image sensor is FPN calibration data of a portion of the image sensitive units in the image sensitive unit array, and each FPN calibration data is used to calculate the compensation data of the raw image data output by an image sensitive unit corresponding to the FPN calibration data.

In some embodiments, compensating the raw image data according to the compensation data includes adding or subtracting the compensation data from the raw image data.

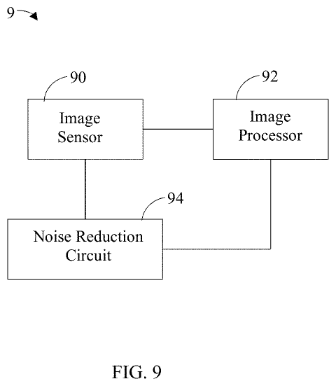

FIG. 9 is a schematic structural diagram of an image processing apparatus 9 according to an embodiment of the present disclosure. The image processing apparatus 9 includes an image sensor 90, an image processor 92, and a noise reduction circuit 94. The image sensor 90 is configured to output raw image data. The image processor 92 is communicatively coupled to the image sensor 90 for processing image data. The noise reduction circuit 94 pre-stores FPN calibration data of the image sensor 90, and communicates with the image sensor 90 and the image processor 92, respectively. The noise reduction circuit 94 is configured to perform noise reduction processing on the raw image data output by the image sensor.

The noise reduction process includes: acquiring raw image data output by the image sensor; calculating compensation data of the raw image data according to the FPN calibration data, and compensating the raw image data according to the compensation data.

In some embodiments, the image processor 92 is configured to acquire exposure information corresponding to the raw image data, and when the exposure information corresponding to the raw image data is determined to meet a predetermined condition, enable the noise reduction circuit to perform the noise reduction process; and /or,

the image processor 92 is configured to acquire the FPN calibration data of the image sensor 90 from the noise reduction circuit 94, and enable the noise reduction circuit 94 to perform the noise reduction process when it is determined that the FPN calibration data of the image sensor 90 is successfully verified.

In some embodiments, the exposure information includes an exposure gain.

In some embodiments, the compensation level is positively correlated with the exposure gain, the greater the exposure gain, the greater the compensation level.

In some embodiments, when the exposure gain corresponding to the raw image data is not less than the exposure gain corresponding to the FPN calibration data, it is determined that the exposure information corresponding to the raw image data satisfies a predetermined condition.

In some embodiments, the exposure gain is determined based on a product of analog gain and digital gain.

In some embodiments, the noise reduction circuit 94 also pre-stores check data for the FPN calibration data of the image sensor.

In some embodiments, the image processor 92 is further configured to acquire, from the noise reduction circuit 94, the check data for the FPN calibration data of the image sensor 90, and when it is determined, based on the FPN calibration data and the check data, that the FPN calibration data of the image sensor 90 is successfully verified, enable the noise reduction circuit 94 to perform the noise reduction process.

In some embodiments, the noise reduction circuit 94 is further configured to receive a compensation level transmitted from the image processor 92, and calculate the compensation data of the raw image data based on the FPN calibration data and the compensation level received from the image processor 92.

In some embodiments, the compensation level is determined based on exposure information corresponding to the FPN calibration data of the image sensor 90 and exposure information corresponding to the raw image data, and/or based on the temperature information corresponding to the FPN calibration data of the image sensor 90 and the temperature information corresponding to the raw image data.

In some embodiments, the compensation data is calculated based on a product of the FPN calibration data and the compensation level.

In some embodiments, the image sensor 90 includes an image sensitive unit array, and the number of FPN calibration data is less than the number of image sensitive units in the image sensitive unit array.

In some embodiments, calculating the compensation data of the raw image data according to the pre-stored FPN calibration data of the image sensor includes:

for one column of image sensitive units in the image sensitive unit array, calculating compensation data of raw image data output by the column of image sensitive units based on FPN calibration data of the column of image sensitive units, where the number of FPN calibration data of the column of image sensitive units is smaller than the number of image sensitive units in the column of image sensitive units.

In some embodiments, the raw image data is image data of a Bayer domain.

In some embodiments, the column of image sensitive units is configured to output image data of a class of M-channel, and the FPN calibration data of the column of the image sensitive units includes FPN calibration data of the class of M-channel, and the number of the FPN calibration data corresponding to each class of channel is smaller than the number of image sensitive units corresponding to that class of channel.

In some embodiments, the image sensitive units in the column are configured to output image data of a class of M-channel, and the number of FPN calibration data of the column of the image sensitive units is M; and

calculating the compensation data of the raw image data according to the pre-stored FPN calibration data of the image sensor includes:

respectively calculating the compensation data of the image data of the class of M-channel in the column of the image sensitive units according to M number of FPN calibration data, where each FPN calibration data is used to calculate compensation data of all image data in one class of channel.

In some embodiments, the FPN calibration data of the image sensor is FPN calibration data of a portion of the image sensitive units in the image sensitive unit array, and each FPN calibration data is used to calculate the compensation data of the raw image data output by an image sensitive unit corresponding to the FPN calibration data.

In some embodiments, compensating the raw image data according to the compensation data includes adding or subtracting the compensation data from the raw image data.

In addition, those skilled in the art may make various other variations and modifications in accordance with the technical concept of the present disclosure, and all such variations and modifications are within the scope of the claims of the present disclosure.

What is claimed is:

1. An image noise calibration apparatus, comprising a processor, wherein the processor executing a computer readable instruction set implements:
acquiring raw image data output by an image sensor, wherein the image sensor includes an image sensitive unit array, and the raw image data is output by the image sensitive unit array in an optical black state; and
determining fixed pattern noise (FPN) calibration data of the image sensor based on the raw image data output by the image sensitive unit array, wherein the FPN calibration data is used for noise reduction of the image sensitive unit array, and the number of the FPN calibration data is less than the number of image sensitive units in the image sensor.

2. The image noise calibration apparatus of claim 1, wherein determining the FPN calibration data of the image sensor based on the raw image data output by the image sensing unit array further includes:
for one column of image sensitive units in the image sensitive unit array, determining FPN calibration data of the column of image sensitive units based on raw image data output by the column of image sensitive units, wherein the FPN calibration data of the column of image sensitive units is used for noise reduction of the column of image sensitive units, and the number of FPN calibration data of the column of image sensitive units is less than the number of image sensitive units in the column of image sensitive units.

3. The image noise calibration apparatus of claim 2, wherein the image sensitive units in the column are configured to output image data of a class of M-channel, the FPN calibration data of the column of image sensitive units includes FPN calibration data of the class of M-channel, and the number of FPN calibration data corresponding to each class of channel is smaller than the number of image sensitive units corresponding to that class of channel.

4. The image noise calibration apparatus of claim 3, wherein the raw image data is image data of a Bayer domain.

5. The image noise calibration apparatus of claim 2, wherein the image sensitive units in the column are configured to output image data of a class of M-channel, and the number of FPN calibration data of the column of image sensitive units is M.

6. The image noise calibration apparatus of claim 5, wherein:
the raw image data is image data of an RGB Bayer domain; and
the class of M-channel includes a blue channel, a red channel, and two green channels.

7. The image noise calibration apparatus of claim 2, wherein the number of FPN calibration data of the column of image sensitive units is one.

8. The image noise calibration apparatus of claim 1, wherein determining the FPN calibration data of the image sensor based on the raw image data output by the image sensitive unit array further includes:
determining FPN data of each image sensitive unit based on the raw image data output by the image sensitive unit array; and
determining FPN data, among FPN data of each of the image sensitive units, that is larger than a threshold as the FPN calibration data of the image sensor.

9. The image noise calibration apparatus of claim 1, wherein the processor executing the computer readable instruction set further implements:
acquiring a dark current correction value of the image sensitive unit array; and
determining the FPN calibration data of the image sensor based on the raw image data output by the image sensing unit array further includes:
determining the FPN calibration data of the image sensor based on the raw image data output by the image sensitive unit array and the dark current correction value of the image sensitive unit array, wherein the FPN calibration data of the image sensor is a value with the dark current correction value being removed.

10. The image noise calibration apparatus according to any claim 1, wherein the quantity of the raw image data is at least one frame; and
determining the FPN calibration data of the image sensor based on the raw image data output by the image sensing unit array further includes:
determining FPN calibration data for each frame based on each frame of raw image data output by the image sensitive unit array, and averaging the FPN calibration data of each frame to obtain the FPN calibration data of the image sensor; or,
determining the FPN calibration data of the image sensor based on an average of the at least one frame of raw image data output by the image sensitive unit array.

11. The image noise calibration apparatus of claim 1, wherein the processor executing the computer readable instruction set further implements:
storing the FPN calibration data of the image sensor in a storage unit of a noise reduction module.

12. The image noise calibration apparatus of claim 11, wherein the noise reduction module is an image sensor, an image processor, or a noise reduction circuit connected to the image sensor.

13. The image noise calibration apparatus of claim 11, wherein the processor executing the computer readable instruction set further implements:
generating check data according to the FPN calibration data; and
storing the FPN calibration data and the check data in the storage unit of the noise reduction module.

14. The image noise calibration apparatus of claim 13, wherein the check data is generated using a cyclic redundancy check algorithm.

15. The image noise calibration apparatus of claim 13, wherein the processor executing the computer readable instruction set further implements:
verifying the FPN calibration data based on the check data.

16. The image noise calibration apparatus of claim 1, wherein, before the image sensor acquires an image, the processor executing the computer readable instruction set further implements:
determining that no valid FPN calibration data is stored in the image sensitive unit array.

17. The image noise calibration apparatus of claim 16, wherein determining that no valid FPN calibration data is stored in the image sensitive unit array further includes:
reading data in a storage unit, if the FPN calibration data does not exist or the FPN calibration data fails to be verified, it is determined that no valid FPN calibration data is stored in the image sensitive unit array.

18. An image noise reduction apparatus, comprising a noise reduction module, wherein the noise reduction module is configured to perform a noise reduction process on raw image data output by an image sensor, and the noise reduction process includes:
acquiring the raw image data output by the image sensor;
calculating compensation data of the raw image data according to pre-stored FPN calibration data of the image sensor; and
compensating the raw image data based on the compensation data.

19. The image noise reduction apparatus of claim 18, wherein calculating the compensation data of the raw image data according to the pre-stored FPN calibration data of the image sensor and the raw image data further includes:
obtaining a compensation level; and
calculating the compensation data of the raw image data based on the FPN calibration data and the compensation level.

20. The image noise reduction apparatus of claim 18, wherein the noise reduction process is performed when it is determined that exposure information corresponding to the raw image data satisfies a predetermined condition, and/or when it is determined that the FPN calibration data of the image sensor is successfully verified.
